(19) United States
(12) Patent Application Publication
(10) Pub. No.: US 2010/0045449 A1
(43) Pub. Date: Feb. 25, 2010

(54) Method for detecting a traffic space

(76) Inventor: Fridtjof Stein, Ostfildern (DE)

Correspondence Address: KENYON & KENYON LLP, ONE BROADWAY, NEW YORK, NY, 10004, US

(21) Appl. No.: 12/308,197

(22) PCT Filed: May 23, 2007
(86) PCT No.: PCT/EP2007/055014

§ 371 Date: Oct. 23, 2009

(30) Foreign Application Priority Data
Jun. 12, 2006 (DE) 10 2006 027 123.8

(51) Int. Cl. H04N 5/222; B60Q 1/00

(52) U.S. Cl. 340/435; 348/149; 348/E05.022

(57) ABSTRACT

A method is described for detecting a traffic space comprising a driver assistance system including a monocular image sensor. The image sensor produces chronologically successive images of the traffic space. The images of the image sequence are used to ascertain the visual flow and examine it for discontinuities. Discontinuities found in the visual flow are assigned to objects in the traffic space.

### FIELD OF THE INVENTION

The present invention relates to a method for detecting a traffic space.

### BACKGROUND INFORMATION

Methods for detecting the traffic space using image sensors assigned to driver assistance systems are being used in modern vehicles to an increasing extent. Such driver assistance systems support the driver, for example in maintaining the selected lane, in making an intended lane change, in maintaining the safety distance from preceding vehicles, and while driving in poor visibility conditions, for example at night or in bad weather. Frequently, assistance functions such as LDW (lane departure warning), LKS (lane keeping support), LCA (lane change assistant) and ACC (automatic (adaptive) cruise control) are implemented. In order to detect the vehicle surroundings, at least one image sensor is provided in such a driver assistance system. A video camera based on CCD or CMOS technology may be used as an image sensor, the video camera typically being installed in the vehicle with its viewing direction aimed forward.

Mono cameras are predominately used for reasons of cost. However, because mono cameras provide only a two-dimensional image of the vehicle surroundings, three-dimensional structures cannot be readily extracted from the video signals provided by the mono camera. To that end, up until now it has always been necessary to use modeling to be able to detect three-dimensional objects, for example other vehicles, traffic signs, pedestrians, the road course, etc. If not only one image is observed, but instead a plurality of chronologically successive images of the mono camera, i.e., a so-called image sequence, the shifts that can be detected in successive images provide information concerning the three-dimensional arrangement of the objects in the vehicle surroundings. However, such a measurement is precise only when scaling is not taken into account. For example, it is not readily possible to make the distinction of whether a distant object is moving rapidly or a close object is moving slowly, since both objects leave the same information on the image sensor.

Scientific investigations are already known which have been focused on the task of deriving spatial information from a sequence of two-dimensional images.

Spoerri, Anselm:

The early Detection of Motion Boundaries, Technical Report 1275, MIT Artificial Intelligence Laboratory;

Black, M. J., and Fleet, D J.:

Probabilistic Detection and Tracking of Motion Discontinuities International Conference on Computer Vision 1999, Corfu, Greece;

H.-H. Nagel, G. Socher, H. Kollnig, and M. Otte:

Motion Boundary Detection in Image Sequences by Local Stochastic Tests. Proc. Third European Conference on Computer Vision (ECCV '94), 2-6 May 1994, Stockholm/Sweden, J.-O. Eklundh (Ed.), Lecture Notes in Computer Science 801 (Vol. II), Springer-Verlag Berlin, Heidelberg, New York 1994, pp. 305-315.

Most of these proposals are neither real-time capable nor robust enough for automotive engineering applications. Frequently, simplifying assumptions are also made, for example self-moving objects in the image scene are excluded, which do not apply in practice for vehicle surroundings.

Furthermore, an exterior view method for motor vehicles is discussed in DE 4332612 A1, which is characterized by the following steps: Recording an exterior view from the host motor vehicle which is in motion; detection of a movement of a single point in two images as a visual flow, one of the two images being recorded at an earlier point in time and the other of the two images being recorded at a later point in time; and monitoring of a correlation of the host motor vehicle with regard to at least either a preceding vehicle or an obstruction on the road, a danger rate being evaluated as a function of a variable and a location of a vector of a visual flow which is derived from a point on at least either the preceding motor vehicle, the following motor vehicle, or the obstruction on the road. Taking into account the fact that the visual flow becomes larger as the distance between the host vehicle and the preceding motor vehicle or obstruction becomes smaller or as the relative speed becomes greater, this known method is designed in such a way that the danger can be evaluated from the magnitude of a visual flow which is derived from a point on a preceding vehicle or an obstruction on the road.

### SUMMARY OF THE INVENTION

### Advantageous Effects

The approach of the exemplary embodiments and/or exemplary methods of the present invention having the features described herein avoids the disadvantages of the known approaches. It is real-time capable and robust and is therefore suitable in a particular manner for automotive engineering applications having rapidly changing image content. As future driver assistance systems are intended to provide the driver not only with an image of the vehicle surroundings but are also intended to convey additional information and warnings, the system according to the present invention is in particular well suited for use in such systems. Namely, it makes possible the detection of static and moved obstructions from the image flow and the segmentation of the image into roads, static and moved objects of interest, and other features. In a manner which is advantageous in particular, for example, warning signs may be detected as static objects in the images. It is thus possible to parameterize a lane detection function of the driver assistance system in order to be better able to detect a construction site situation which is critical in particular. Furthermore, reflector posts detected as static objects are capable of advantageously supporting a lane guidance function of the driver assistance system if no easily detectable markings are present on the road surface. The detection of moving objects and their insertion into the display observed by the driver make a warning possible which is effective in particular even in poor visibility conditions, in particular when driving at night. Based on a flow analysis, the segmented road course makes an exact determination of the vehicle's own movement possible. This makes it possible to support the measuring accuracy of other on-board sensors. For example, it is thus possible to compensate for drift in a yaw rate sensor. In a manner which is advantageous in particular, the exemplary embodiments and/or exemplary methods of the present invention may also be used to detect the condition of the terrain along the road surface based on a model. For example it is thus possible to detect if a ditch runs along the edge of the road surface or if the road is bordered by a steep slope. In an evasion maneuver which may be necessary, these facts may be of great significance in estimating the risk of such a maneuver. This will result in valuable additional functions for future driver assistance systems. For example, the terrain profile adjacent to the road surface may be taken into consideration for the support function LDW (lane departure warning) or for an evasion recommendation in the case of danger.

Furthermore, the system of the present invention may also be used advantageously in highly advanced passenger protection systems having a precrash function. Of course, the exemplary embodiments and/or exemplary methods of the present invention may also be used with cameras positioned on the side or the rear of the vehicle in order to detect images from these areas of the vehicle surroundings.

Exemplary embodiments of the present invention are explained in greater detail below with reference to the drawing.

### BRIEF DESCRIPTION OF THE DRAWINGS

FIG. 1 shows a simplified schematic block diagram of a driver assistance system.

FIG. 2 shows the representation of chronologically staggered images of an image sensor.

FIG. 3 shows a flow chart including method steps.

FIG. 4 shows an image of a traffic space detected by an image sensor.

FIG. 5 shows flow lines (ISO flow lines) of the visual flow derived from the image of FIG. 4.

FIG. 6 shows a first representation of a night view image.

FIG. 7 shows a second representation of a night view image.

FIG. 8 shows an image of an image sensor having inserted ISO flow lines.

FIG. 9 shows an image of an image sensor having inserted ISO flow lines.

FIG. 10 shows an image of an image sensor having inserted ISO flow lines.

FIG. 11 shows an image of an image sensor having inserted ISO flow lines.

FIG. 12 shows an image of an image sensor having inserted ISO flow lines.

FIG. 13 shows an image of an image sensor having inserted ISO flow lines.

FIG. 14 shows an image of an image sensor having inserted ISO flow lines.

FIG. 15 shows an image of an image sensor having inserted ISO flow lines.

### DETAILED DESCRIPTION

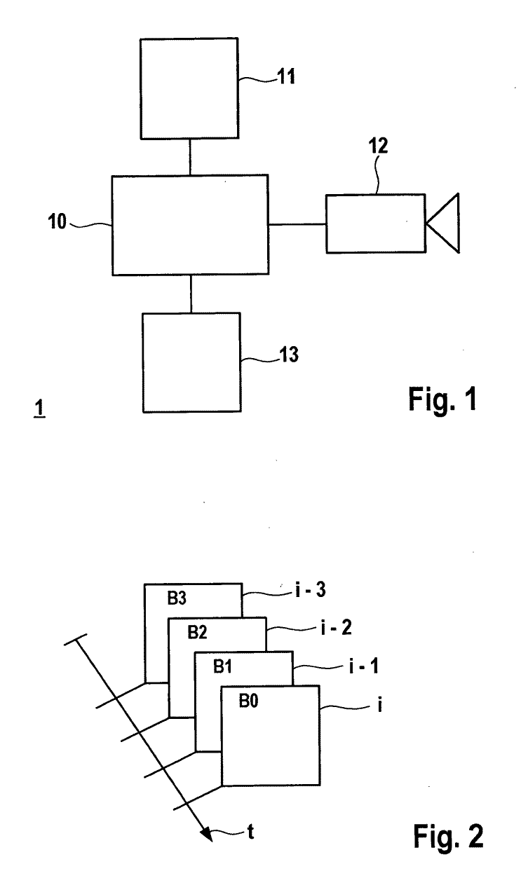

The exemplary embodiments and/or exemplary methods of the present invention is used in a driver assistance system which is provided in a motor vehicle for the support of the driver. FIG. 1 shows a simplified schematic block diagram of such a driver assistance system. Driver assistance system 1 includes at least one monocular image sensor 12 for detecting the traffic space traveled by the motor vehicle. This image sensor 12 is, for example, a camera based on CCD technology or CMOS technology. In addition to image sensor 12, numerous additional sensors may be provided, for example radar/lidar or ultrasound sensors which, however, are not shown in detail in FIG. 1 but instead are represented by the block diagram. Image sensor 12 is connected to a control unit 10. The additional sensors (block 11) are also connected to control unit 10. Control unit 10 processes the signals of the sensors.

Also connected to control unit 10 is a function module which in particular connects driver assistance system 1 to other systems of the vehicle. For example, a connection of driver assistance system 1 to warning systems of the vehicle is necessary for implementation of the LDW function (LDW=lane departure warning).

For the implementation of the LKS function (lane keeping support), a connection to the vehicle's steering system may be necessary. Instead of an expensive stereo system, frequently only a monocular image sensor 12 is provided in a driver assistance system for reasons of cost. Image sensor 12 is typically installed in the vehicle with its viewing direction aimed forward and thus may detect the area of the traffic space lying in front of the vehicle. Image sensor 12 may also have night vision capability in order to improve visibility in darkness and poor weather conditions. One disadvantage of monocular image sensors is that it is not readily possible to extract three-dimensional structures from the images supplied by the image sensor. To this end, model knowledge implemented in the driver assistance system is necessary to detect three-dimensional objects from the traffic space in monocular images, for example other vehicles, traffic signs, pedestrians, and the like.

If not only a monocular image is observed but instead so-called sequences of images made up of a plurality of images, it is then possible to provide information concerning the presence and the location of three-dimensional objects from shifts occurring from image to image. FIG. 2 shows, for example, such a sequence of images B0, B1, B2, B3 along a time axis t which were obtained at different points in time i, i-1, i-2, i-3. However, the measurement of objects in these images is precise only when scaling is not taken into account. The differentiation as to whether a distant object is moving rapidly or a close object is moving slowly cannot not be readily made, since both of them leave behind the same information on image sensor 12. This is where the approach of the exemplary embodiments and/or exemplary methods of the present invention comes into play, it being based on an analysis of the visual flow or image flow derived from the images.

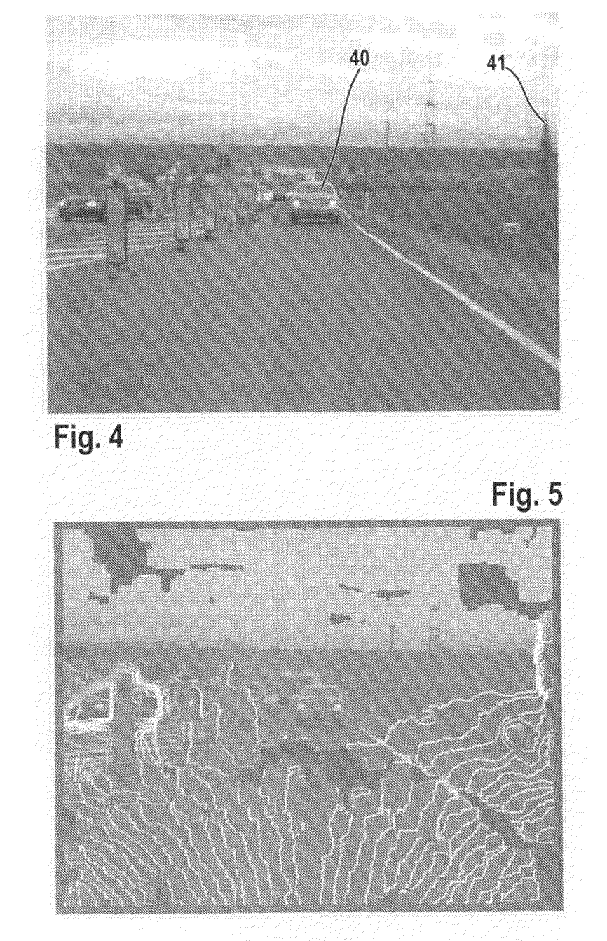

A significant step in analyzing the image flow is the segmentation of the image. The exemplary embodiments and/or exemplary methods of the present invention is directed to such a segmentation which is based on discontinuities in the visual flow. These discontinuities are described below as flow edges. These flow edges occur in particular on raised objects. This will be explained in greater detail below with reference to FIG. 4 and FIG. 5. FIG. 4 shows a monocular image of a traffic space recorded by image sensor 12, in which the vehicle equipped with driver assistance system 1 (host vehicle) is traveling. Since image sensor 12 is installed as an anticipatory sensor, the image shown in FIG. 4 shows the road course in the direction of travel of the host vehicle. The host vehicle is apparently following another preceding vehicle precisely in the area of a construction site secured by a warning sign. Vehicles in oncoming traffic are approaching in the opposite lane. A tree 41 is identifiable on the right side of the host's lane. FIG. 5 also shows an image of the traffic space recorded by image sensor 12, flow lines (ISO flow lines) of the visual flows derived from the monocular images now having been inserted in addition, the flow lines being shown as thinly drawn irregular lines. Of particular interest are discontinuities of the visual flow which normally occur on raised objects, in particular when they occur frequently. In FIG. 5, this is the case in particular of the warning sign to the left and the tree to the right. These areas are described as flow edges. In the absence of an appropriate structure, no flow information is present in the area of the sky. The so-called FOE (focus of expansion) is located in the center of the image. This is a point for which no reliable 3-D information is extractable from its near surroundings. For that reason, the vehicle preceding the host vehicle is not visible in the flow image.

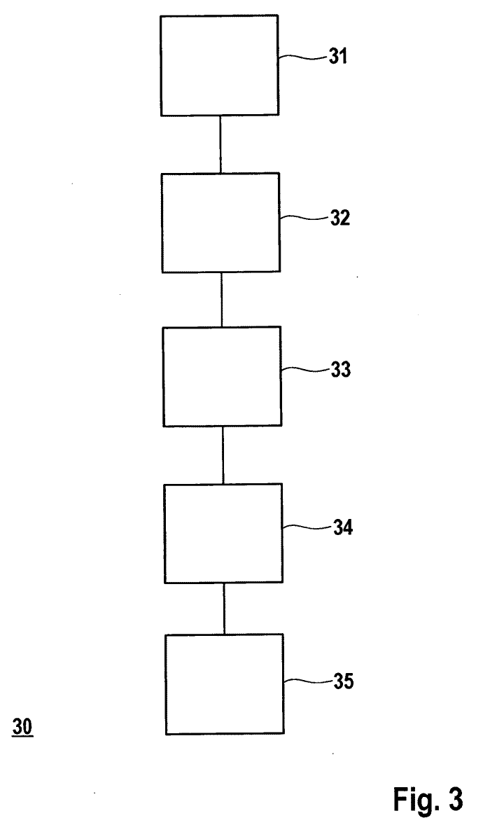

Based on the simple flow chart shown in FIG. 3, the steps performed according to the exemplary embodiments and/or exemplary methods of the present invention will be summarized once more below. In a first step, monocular images of the traffic space are generated using image sensor 12. In a second step 32, the visual flow is extracted from these images. In a third step 30, the visual flow is examined for discontinuities. In another step 40, the image is segmented based on the discovered discontinuities of the visual flow. This segmentation makes it possible to classify objects of the traffic space. These objects include self-moving objects such as, for example, other highway users, static objects such as, for example, traffic directing devices (see warning signs and traffic signs) or even the road itself and the areas of terrain adjacent to the road. In another step 50, control of the vehicle or of its systems may take place, if necessary, as a function of a risk assessment based on the analysis of discontinuities of the visual flow.

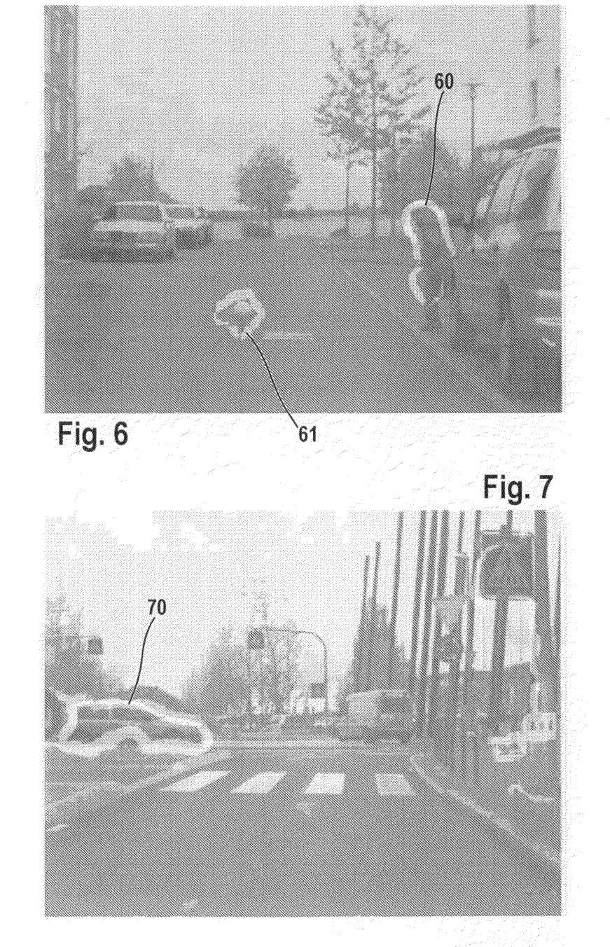

For example, after the warning signs shown in FIG. 4 and FIG. 5 are recorded, the danger zone construction site may be recognized. Intervention in the braking system and/or the drive train of the vehicle may then make it possible to set an adjusted speed of the vehicle in order to master the construction site situation without risk. Furthermore, reflector posts detected by the exemplary embodiments and/or exemplary methods of the present invention are able to support a safe lane guidance of the vehicle even if clearly recognizable lane markings are no longer present. Traffic signs may also be detected in this manner. Self-moving objects from the traffic space are distinguished in that the discontinuities of the visual flow associated with them change their location as a function of time. This property is used in the segmentation of the images in order to differentiate self-moving objects from static objects. In an advantageous manner, detected self-moving objects make a danger warning possible, for example by insertion into a night view image of a night vision-capable driver assistance system 1. Two examples of this are shown in FIG. 6 and FIG. 7. FIG. 6 shows a night view image and, inserted into it, a child playing with a ball which jumps in front of the host vehicle from the right side of the lane. In a night view image, FIG. 7 shows an intersection with another vehicle approaching in the cross traffic of the intersection.

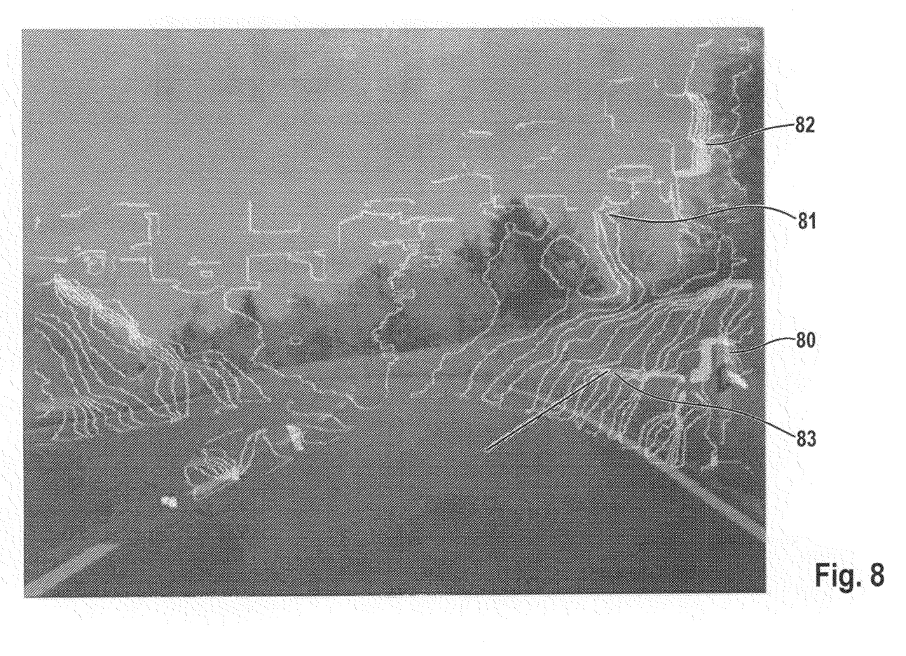

In addition to the traffic guiding devices such as traffic signs, reflector signs and the like, the method of the present invention may also be used to detect structures on the road shoulder, vegetation following the course of the road and even terrain formations bordering the road and use them for an appropriate response of the driver assistance system. Thus, as another example FIG. 8 shows an image of an image sensor having inserted ISO flow lines of the visual flow and discontinuities of the visual flow detectable therein. The image shown in FIG. 8 shows a road having a left-hand curve. Flow edges that are prominent in particular are located on a reflective post in the right foreground, at trees 81, 82 in the vegetation and at a section of terrain in the form of incline 83 to the right of the road.

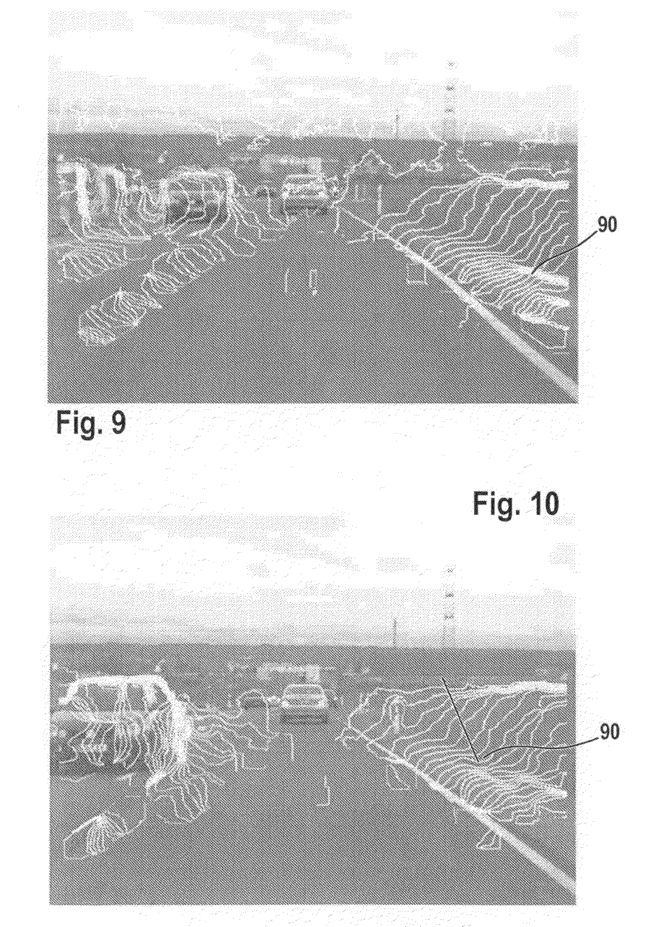

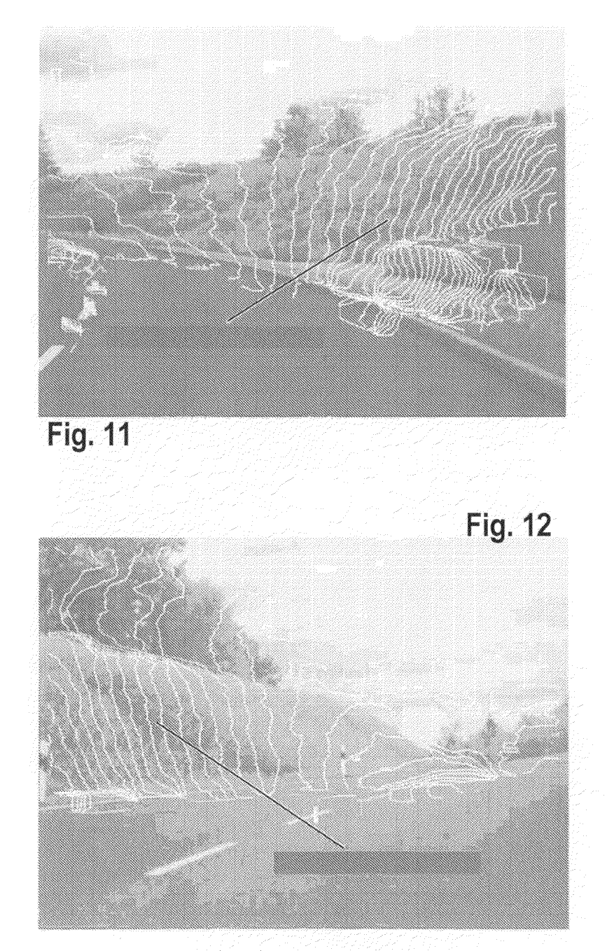

FIG. 9 and FIG. 10 show images and discontinuities of the visual flow that make it possible to infer a ditch adjoining the right side of the depicted road. The images and discontinuities of the visual flow shown in FIG. 11 and FIG. 12 show a road course with steep inclines bordering the road on the right and left. The detection of such terrain formations may support the driver assistance system in selecting a suitable evasion strategy in the event of danger. In the situation shown, leaving the road due to the steeply ascending slopes would be associated with a comparatively high risk. This risk assessment is extremely important for future driver assistance systems that also provide intervention into the vehicle's steering.

The segmented road further allows an exact determination of the host vehicle's movement based on the flow analysis. The measurement accuracy of other sensors of the driver assistance system present in the vehicle may be supported. Thus, drift may be compensated, for example in a yaw rate sensor.

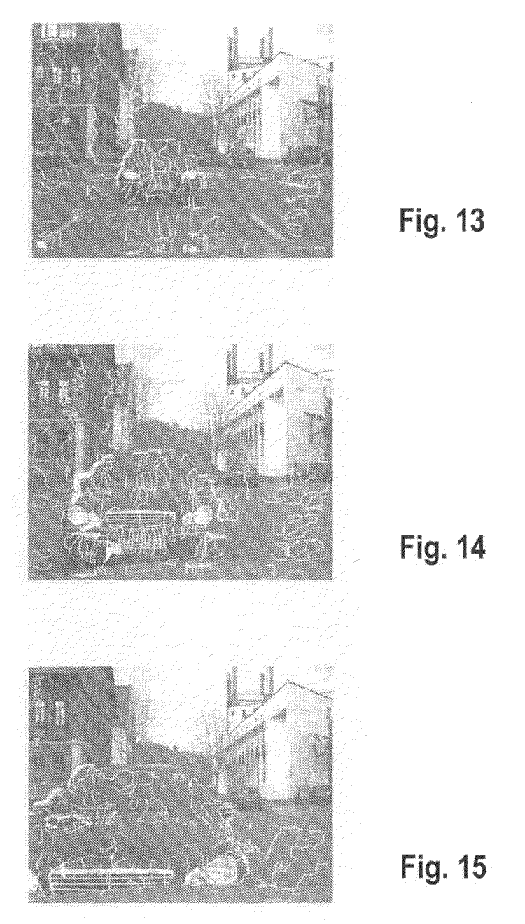

The method of the present invention may also be used advantageously in image sequences provided by image sensors aimed to the side or backward. An advantageous application in connection with a precrash sensor of the passenger protection system is also conceivable. FIG. 13, FIG. 14 and FIG. 15 show as an example an image sequence delivered by an image sensor 12 in which the discontinuities of the visual flow make it possible to infer another vehicle approaching the host vehicle on a collision course.

1-12. (canceled)

13. A method for detecting a traffic space using a driver assistance system having a monocular image sensor (12), the method comprising:
generating, using the monocular image sensor, chronologically successive images of the traffic space;
ascertaining the visual flow in the individual images;
examining the visual flow for discontinuities; and
assigning discontinuities found in the visual flow to objects of the traffic space.

14. The method of claim 13, wherein obstructions in the traffic space are inferred from a location of the discontinuities.

15. The method of claim 13, wherein a moving object is inferred from a change of a location of the discontinuities of the visual flow.

16. The method of claim 13, wherein a condition of the terrain next to the road is inferred from detected discontinuities of the visual flow.

17. The method of claim 13, wherein identified discontinuities of the visual flow are used to control the driver assistance system and any necessary and additional on-board systems.

18. The method of claim 13, wherein discontinuities of the visual flow are used in connection with warning strategies.

19. The method of claim 13, wherein warnings derived from discontinuities of the visual flow are fed into the driver information system.

20. The method of claim 13, wherein warnings derived from discontinuities of the visual flow are inserted into a night view image of the driver assistance system.

21. The method of claim 13, wherein information derived from a discontinuity of the visual flow is used for controlling a passenger protection system.

22. The method of claim 13, wherein information derived from a discontinuity of the visual flow is used for a precrash detection system.

23. The method of claim 13, wherein information derived from a discontinuity of the visual flow is used for lane detection and lane guidance of the vehicle.

24. The method of claim 13, wherein information derived from a discontinuity of the visual flow is used for plausibility testing of sensors to improve their measuring accuracy.
